(19) United States
(12) Patent Application Publication
(10) Pub. No.: US 2008/0088180 A1
(43) Pub. Date: Apr. 17, 2008

(54) METHOD OF LOAD SHEDDING TO REDUCE THE TOTAL POWER CONSUMPTION OF A LOAD CONTROL SYSTEM

(76) Inventors: Audwin W. Cash, Bethlehem, PA (US); William H. Howe, Pennsburg, PA (US); Joe Suresh Jacob, Macungie, PA (US); Timothy S. Majewski, New Tripoli, PA (US); Christopher J. Rigatti, Philadelphia, PA (US); Dragan Veskovic, Allentown, PA (US)

Correspondence Address: OSTROLENK FABER GERB & SOFFEN, 1180 AVENUE OF THE AMERICAS, NEW YORK, NY, 100368403, US

(21) Appl. No.: 11/870,889

(22) Filed: Oct. 11, 2007

Related U.S. Application Data
(60) Provisional application No. 60/851,383, filed on Oct. 13, 2006.
(60) Provisional application No. 60/858,844, filed on Nov. 14, 2006.

(51) Int. Cl. H02J 3/12

(52) U.S. Cl. 307/31; 307/11

(57) ABSTRACT

A lighting control system is operable to control the amount of power delivered to a plurality of electrical loads. The lighting control system includes load control devices (such as digital electronic dimming ballasts), motorized window treatments, controllers, processors, and personal computers. The personal computer is preferably executing a graphical user interface (GUI) software, which allows a user to configure and monitor the operation of the lighting control system. The lighting control system offers a load shedding functionality without using power meters. Each load control device transmits its current intensity level to the personal computer, which is operable to determine a total power consumption of the lighting control system. If the total power consumption exceeds a predetermined power threshold, the personal computer causes the load control devices to shed loads.

### RELATED APPLICATIONS

This application claims priority from commonly-assigned U.S. Provisional Application Ser. No. 60/851,383, filed Oct. 13, 2006, and U.S. Provisional Application Ser. No. 60/858,844, filed Nov. 14, 2006, both entitled LIGHTING CONTROL SYSTEM. The entire disclosures of both applications are hereby incorporated by reference.

### BACKGROUND OF THE INVENTION

1. Field of the Invention

The present invention relates to a load control system comprising a plurality of load control devices for controlling the amount of power delivered to a plurality of electrical loads from an AC power source, and more particularly, to a method of shedding loads of a lighting control system in response to an estimation of the amount of power presently being consumed by the lighting control system.

2. Description of the Related Art

Reducing the total cost of electrical energy is an important goal for many electricity consumers. Most electricity customers are charged for the total amount of energy consumed during a billing period. However, since the electrical utility companies must spend money to ensure that their equipment is able to provide energy in all situations, including peak demand periods, many electrical utility companies charge their electricity consumers at rates that are based on the peak power consumption during the billing period, rather than the average power consumption during the billing period. Thus, even if an electricity consumer consumes power at a very high rate for only a short period of time, the electricity consumer will face a significant increase in its total power costs.

Therefore, many electricity consumers use a “load shedding” technique. This technique involves closely monitoring the amount of power presently being consumed by the electrical system. Additionally, the electricity consumers “shed loads”, i.e., turn off some electrical loads, if the total power consumption nears a peak power billing threshold set by the electrical utility. Prior art electrical systems of electricity consumers have included power meters that measure the instantaneous total power being consumed by the system. Accordingly, a building manager of such an electrical system is operable to visually monitor the total power being consumed and to turn off electrical loads to reduce the total power consumption of the electrical system if the power nears a billing threshold.

Many electrical utility companies offer a demand response program, in which the electricity consumers agree to shed loads during peak demand periods in exchange for incentives, such as reduced billing rates or other means of compensation. For example, the electricity utility company may request that a participant in the demand response program shed loads during the afternoon hours of the summer months when demand for power is great. Some prior art lighting control systems have offered a load shedding capability in which the intensities of all lighting loads are reduced by a fixed percentage, e.g., by 25%, in response to an input provided to the system. Such a lighting control system is described in commonly-assigned U.S. Pat. No. 6,225,760, issued May 1, 2001, entitled FLUORESCENT LAMP DIMMER SYSTEM, the entire disclosure of which is hereby incorporated by reference.

Since power meters tend to be rather expensive, most prior art electrical systems have included only one power meter monitoring the total power being consumed by the electrical system. Alternatively, some prior art lighting control systems, such as the Digital microWATT fluorescent lighting control system manufactured by the assignee of the present invention, have include lighting controllers that are operable to measure the power being consumed by a connected lighting load. Specifically, the lighting controllers included current transformers to measure the current flowing into the lighting controller and thus the power consumed by the lighting controller and the lighting load. However, lighting controllers including current transformers are also expensive.

Thus, there exists a need for a load control system that is operable to determine the power consumed by each individual electrical load in order to determine the total power being consumed by the load control system without using expensive power meters or current transformers.

### SUMMARY OF THE INVENTION

According to the present invention, a method of controlling plurality of electrical loads comprises the steps of estimating a present amount of power being consumed by each of the plurality of electrical loads, and determining the total amount of power presently being consumed by all of the plurality of electrical loads in response to the step of determining a present amount of power being consumed by each of the plurality of electrical loads. Further, the method is operable to provide a load shedding technique by additionally comparing the total amount of power to a threshold amount of power, and controlling the amount of power delivered to the plurality of electrical loads in response to the step of comparing if the total amount of power exceeds the threshold amount of power, such that the plurality of electrical loads consume a second amount of power less than the threshold amount of power.

According to another embodiment of the present invention the present invention, a load control system for controlling the amount of power delivered to a plurality of electrical loads from an AC power source comprises a plurality of load control devices and a central controller operable to determine the total amount of power being delivered to all of the electrical loads. The load control devices are coupled to the electrical loads for control of the amount of power delivered to the electrical loads. Each load control device is characterized by a first value corresponding to the present amount of power being delivered to a corresponding at least one of the electrical loads. A central controller is operatively coupled to the load control devices, such that the load control devices are operable to control the amount of power delivered to the electrical loads in response to the controller. Each of the load control devices is operable to transmit the first value to the controller, and the controller is operable to determine the total amount of power being delivered to all of the electrical loads in response to the first value of each of the plurality of load control devices.

The present invention further provides a method for using a computing device to reduce power usage for a plurality of load devices without using power meters that measure actual power usage. The method comprises the steps of: (1) defining a power usage goal value that represents a preferred amount of power to be used for at least one of the plurality of load devices; (2) estimating a power usage value representing actual power usage for the at least one load device at a particular time; and (3) automatically reducing power to the at least one load device when the power usage value exceeds the power usage goal value until the power usage value is equal to or lower than the power usage goal value.

In addition, the present invention provides a system for reducing power usage for a plurality of load devices by using a load shedding techniques without using power meters that meter actual power usage. The system comprises: (1) means for electronically defining a power usage goal value that represents a preferred amount of power to be used by at least one load device; (2) means for estimating an amount of power usage for the at least one load device at a particular time to calculate a power usage value; and (3) means for automatically reducing power to the at least one load device when the power usage value exceeds the power usage goal value until the power usage value is equal to or lower than the power usage goal value.

According to another aspect of the present invention, a method of automatically reducing power consumption in a load control system is presented. The load control system includes a controller and a plurality of load control devices controlling the amount of power delivered to a plurality of electrical loads. The method comprises the steps of: (1) configuring a load shedding tier defining a load shed parameter for each of the electrical loads; (2) the controller determining the total amount of power presently being consumed by all of the plurality of electrical loads; (3) the controller comparing the total amount of power to a threshold amount of power; (4) the controller automatically transmitting a digital message to the plurality of load control devices if the total amount of power exceeds a threshold amount of power; and (5) the load control devices controlling the amount of power delivered to the electrical loads in accordance with the load shed parameters of the load shedding tier in response to the digital message transmitted by the controller.

According to another embodiment of the present invention, a load control system for automatically controlling the amount of power delivered from an AC power source to a plurality of electrical loads comprises a plurality of load control devices coupled to each of the electrical loads for controlling the amount of power delivered to the electrical loads. They system further comprises a central controller operable to determine the total amount of power presently being consumed by all of the plurality of electrical loads, compare the total amount of power to a threshold amount of power, and automatically transmit a digital message to the plurality of load control devices if the total amount of power exceeds a threshold amount of power. The load control devices are each operable to control the amount of power delivered to the connected electrical load in accordance with a load shed parameter of a load shedding tier in response to the digital message transmitted by the controller.

The present invention further provides a central controller for a load control system having a plurality of load control devices for controlling the amount of power delivered from an AC power source to a plurality of electrical loads. The central controller comprises: (1) means for configuring a load shedding tier defining a load shed parameter for each of the electrical loads; (2) means for determining the total amount of power presently being consumed by all of the plurality of electrical loads; (3) means for comparing the total amount of power to a threshold amount of power; and (4) means for automatically transmitting a digital message to the plurality of load control devices if the total amount of power exceeds a threshold amount of power, such that the load control devices control the amount of power delivered to the electrical loads in accordance with the load shed parameters of the load shedding tier in response to the digital message.

In addition, the present invention provides a load control device of a load control system for controlling the amount of power delivered from an AC power source to an electrical load. The load control device comprises a load control circuit, a control circuit, a memory, and a communication circuit. The load control circuit is adapted to be coupled to the AC power source and the electrical load to control the amount of power delivered to the electrical load. The control circuit is coupled to the load control circuit for controlling the amount of power delivered to the electrical load. The memory is coupled to the control circuit and is operable to store a first load shed parameter for a first load shedding tier. The communication circuit is coupled to the control circuit and is operable to receive a digital message representative of the total power of the load control system exceeding a threshold amount of power. The control circuit is operable to control the amount of power delivered to the electrical load in accordance with the first load shed parameter of the first load shedding tier in response to receiving the digital message a first time.

According to another aspect of the present invention, a method of determining a setpoint of a load control device for controlling the amount of power delivered to an electrical load located in a space comprises the steps of: (1) initially setting the value of the setpoint equal to a desired level; (2) limiting the value of the setpoint to an occupied high-end trim if the space is occupied; (3) limiting the value of the setpoint to a daylighting high-end trim determined by a daylighting procedure; and (4) subsequently reducing the value of the setpoint in response to a load shed parameter.

According to another embodiment of the present invention, a method of controlling the amount of power delivered from an AC power source to an electrical load located in a space, comprises the steps of: (1) receiving a digital message containing a command to control the amount of power delivered to the electrical load to a desired level; (2) detecting if the space is occupied; and (3) determining a daylighting high-end trim using a daylighting procedure. The improvement comprises the steps of: (4) receiving a load shed parameter; and (5) determining the amount of power to be delivered to the electrical load by limiting the amount of power to be delivered to the electrical load to the minimum of the desired level of the digital message, an occupied high-end trim, and the daylighting high-end trim, and by reducing the amount of power to be delivered to the electrical load in response to the load shed parameter.

The present invention further provides a load control device for controlling the amount of power delivered from an AC power source to an electrical load located in a space. The load control device comprises: (1) means for initially setting the value of the setpoint equal to a desired level; (2) means for limiting the value of the setpoint to an occupied high-end trim if the space is occupied; (3) means for limiting the value of the setpoint to a daylighting high-end trim determined by a daylighting procedure; and (4) means for subsequently reducing the value of the setpoint in response to a load shed parameter.

In addition, the present invention provides a load control device of a load control system for controlling the amount of power delivered from an AC power source to an electrical load located in a space. The load control device comprises a load control circuit, a control circuit, a memory, a communication circuit, an occupancy sensor input, and a daylight sensor input. The load control circuit is adapted to be coupled to the AC power source and the electrical load to control the amount of power delivered to the electrical load. The control circuit is coupled to the load control circuit for controlling the amount of power delivered to the electrical load, to the memory for storing a load shed parameter, and to the communication circuit for receiving a digital message representative of a desired amount of power to deliver to the electrical load. The occupancy sensor input receives an occupancy sensor signal representative of whether the space is occupied, such that the control circuit is operable to determine an occupied high-end trim in response to the occupancy sensor signal. The daylight sensor input receives a daylight sensor signal representative of the total illumination in the space, such that the control circuit is operable to determine a daylighting high-end trim in response to the daylighting sensor signal. The control circuit is operable to determine the amount of power to be delivered to the electrical load by limiting the amount of power to be delivered to the electrical load to the minimum of the desired level of the digital message, the occupied high-end trim, and the daylighting high-end trim, and by reducing the amount of power to be delivered to the electrical load in response to the load shed parameter.

Other features and advantages of the present invention will become apparent from the following description of the invention that refers to the accompanying drawings.

### BRIEF DESCRIPTION OF THE DRAWINGS

FIG. 1 is a simplified block diagram of a lighting control system according to the present invention;

FIG. 2 is a simplified block diagram of a digital electronic dimming ballast of the lighting control system of FIG. 1;

FIG. 3 is an example of a format of a ballast power consumption table of the personal computer of the lighting control system of FIG. 1;

FIG. 4 is a flowchart of the load shedding procedure executed by the PC according to the present invention;

FIG. 5 is a flowchart of a load shed parameter update procedure executed by a control circuit of the ballast of FIG. 2; and

FIG. 6 is a flowchart of a setpoint procedure executed periodically by the control circuit of the ballasts of FIG. 2.

### DETAILED DESCRIPTION OF THE INVENTION

The foregoing summary, as well as the following detailed description of the preferred embodiments, is better understood when read in conjunction with the appended drawings. For the purposes of illustrating the invention, there is shown in the drawings an embodiment that is presently preferred, in which like numerals represent similar parts throughout the several views of the drawings, it being understood, however, that the invention is not limited to the specific methods and instrumentalities disclosed.

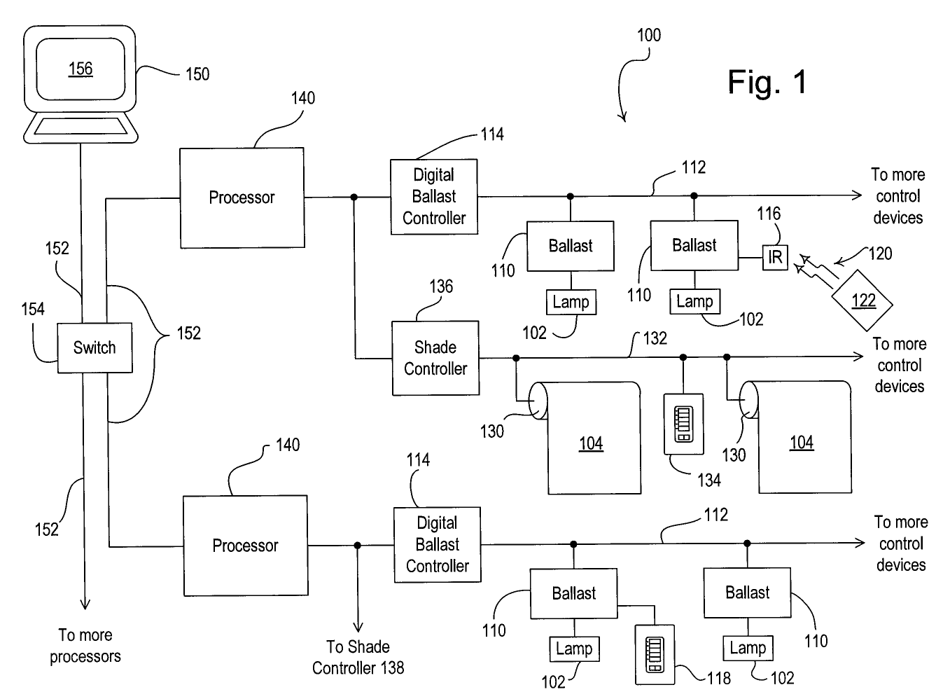

FIG. 1 is a simplified block diagram of a lighting control system 100 according to the present invention. Preferably, the lighting control system 100 is operable to control the level of illumination in a space by controlling the intensity level of the electrical lights in the space and the daylight entering the space. As shown in FIG. 1, the lighting control system 100 is operable to control the amount of power delivered to (and thus the intensity of) a plurality of lighting load, e.g., a plurality of fluorescent lamps 102, using a plurality of digital electronic dimming ballast 110. Further, the lighting control system 100 may additionally include a plurality of other load control devices (not shown), such as dimmers or motor speed control modules, which include appropriate load control circuits that are well known to one having ordinary skill in the art. The lighting control system 100 is further operable to control the position of a plurality of motorized window treatments, e.g., motorized roller shades 104, to control the amount of daylight entering the space.

Each of the fluorescent lamps 102 is coupled to one of the digital electronic dimming ballasts 110 for control of the intensities of the lamps. The ballasts 110 are operable to communicate with each other via digital ballast communication links 112. A common communication protocol used for digital ballast communication links is the digital addressable lighting interface (DALI) protocol. However, the present invention is not limited to ballasts 110 and digital ballast communication links 112 using the DALI protocol.

The digital ballast communication links 112 are also coupled to digital ballast controllers (DBCs) 114, which provide the necessary direct-current (DC) voltage to power the communication links 112, as well as assisting in the programming of the lighting control system 100. Each of the ballasts 110 is operable to receive inputs from a plurality of sources, for example, an occupancy sensor (not shown), a daylight sensor (not shown), an infrared (IR) receiver 116, or a wallstation 118. The ballasts 110 are operable to transmit digital messages to the other ballasts 110 in response to the inputs received from the various sources. Preferably, up to 64 ballasts 110 are operable to be coupled to a single digital ballast communication link 112.

The ballasts 110 may receive IR signals 120 from a handheld remote control 122, e.g., a personal digital assistant (PDA), via the IR receiver 116. The remote control 122 is operable to configure the ballast 110 by transmitting configuration information to the ballasts via the IR signals 120. Accordingly, a user of the remote control 122 is operable to configure the operation of the ballasts 110. For example, the user may group a plurality of ballasts into a single group, which may be responsive to a command from the occupancy sensor. Preferably, a portion of the programming information (i.e., a portion of a programming database) is stored in memory of each of the ballasts 110. An example of the method of using a handheld remote control to configure the ballasts 110 is described in greater detail in co-pending commonly-assigned U.S. patent application Ser. No. 11/375,462, filed Mar. 13, 2006, entitled HANDHELD PROGRAMMER FOR LIGHTING CONTROL SYSTEM, the entire disclosure of which is hereby incorporated by reference.

Referring back to FIG. 1, each of the motorized roller shades 104 comprises an electronic drive unit (EDU) 130. Each electronic drive unit 130 is preferably located inside the roller tube of the associated roller shade 104. The electronic drive units 130 are responsive to digital messages received from a wallstation 134 via a shade communication link 132. The user is operable to open or close the motorized roller shades 104, adjust the position of the shade fabric of the roller shades, or set the roller shades to preset shade positions using the wallstation 134. The user is also operable to configure the operation of the motorized roller shades 104 using the wallstations 134. Preferably, up to 96 electronic drive units 130 and wallstations 134 are operable to be coupled to the shade communication link 132. A shade controller (SC) 136 is coupled to the shade communication link 132. An example of a motorized window treatment control system is described in greater detail in commonly-assigned U.S. Pat. No. 6,983,783, issued Jan. 10, 2006, entitled MOTORIZED SHADE CONTROL SYSTEM, the entire disclosure of which is hereby incorporated by reference.

A plurality of processors 140 allow for communication between a personal computer (PC) 150 and the load control devices, i.e., the ballasts 110 and the electronic drive units 130. Each processor 140 is operable to be coupled to one of the digital ballast controllers 114, which is coupled to the ballasts 110 on one of the digital ballast communication links 112. Each processor 140 is further operable to be coupled to the shade controller 136, which is coupled to the motorized roller shades 114 on one of the shade communication links 114. The processors 140 and the PC 150 are coupled to an inter-processor link 152, e.g., an Ethernet link, such that the PC 150 is operable to transmit digital messages to the processors 140 via a standard Ethernet switch 154.

The PC 150 operates as a central controller for the lighting control system 100 and executes a graphical user interface (GUI) software, which is displayed on a display screen 156 of the PC. The GUI allows the user to configure and monitor the operation of the lighting control system 100. During configuration of the lighting control system 100, the user is operable to determine how many ballasts 110, digital ballast controllers 114, electronic drive units 130, shade controllers 136, and processors 140 that are connected and active using the GUI software. Further, the user may also assign one or more of the ballasts 110 to a zone or a group, such that the ballasts 110 in the group respond together to, for example, an actuation of the wallstation 118. The PC 150 includes a memory for storing the programming data of the lighting control system 100. The PC 150 is operable to transmit an alert to the user in response to a fault condition, such a fluorescent lamp that is burnt out. Specifically, the PC 150 sends an email, prints an alert page on a printer, or displays an alert screen on the screen 156.

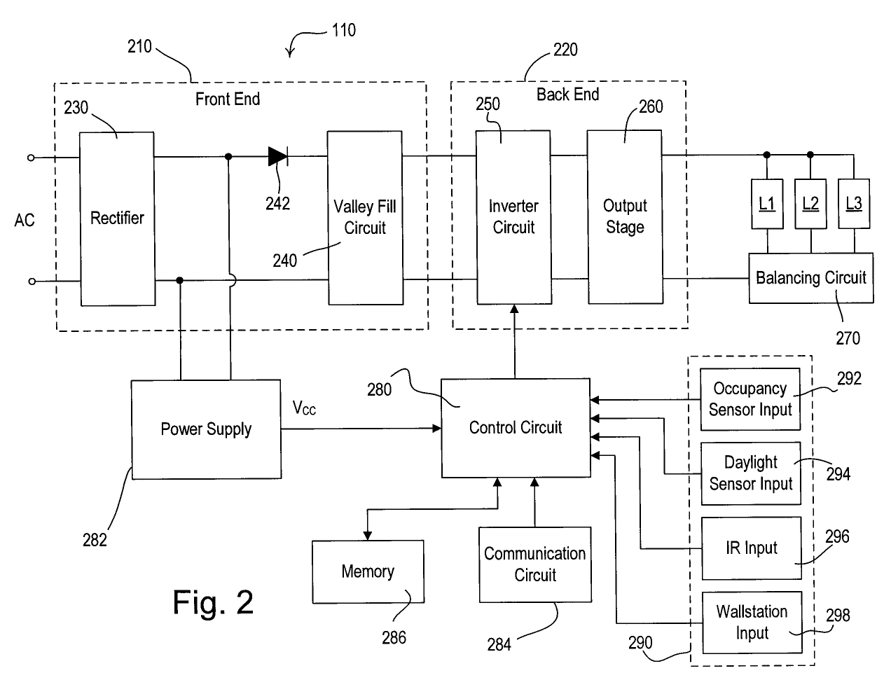

FIG. 2 is a simplified block diagram of the digital electronic dimming ballast 110, which is driving three fluorescent lamps L1, L2, L3 in parallel. The load control circuit of the ballast 110 comprises a front end 210 and a back end 220. The front end 210 includes a rectifier 230 for generating a rectified voltage from an alternating-current (AC) mains line voltage, and a filter circuit, for example, a valley-fill circuit 240, for filtering the rectified voltage to produce a direct-current (DC) bus voltage. The valley-fill circuit 240 is coupled to the rectifier 230 through a diode 242 and includes one or more energy storage devices that selectively charge and discharge so as to fill the valleys between successive rectified voltage peaks to produce a DC bus voltage. The DC bus voltage is the greater of either the rectified voltage or the voltage across the energy storage devices in the valley-fill circuit 240.

The back end 220 includes an inverter 250 for converting the DC bus voltage to a high-frequency AC voltage and an output circuit 260 comprising a resonant tank circuit for coupling the high-frequency AC voltage to the lamp electrodes. A balancing circuit 270 is provided in series with the three lamps L1, L2, L3 to balance the currents through the lamps and to prevent any lamp from shining brighter or dimmer than the other lamps. The front end 210 and back end 220 of the ballast 110 are described in greater detail in commonly-assigned U.S. Pat. No. 6,674,248, issued Jan. 6, 2004, entitled ELECTRONIC BALLAST, the entire disclosure of which is hereby incorporated by reference.

A control circuit 280 generates drive signals to control the operation of the inverter 250 so as to provide a desired load current to the lamps L1, L2, L3. The control circuit 280 is operable to control the intensity of the lamps L1, L2, L3 from a low-end trim (i.e., a minimum intensity) to a high-end trim (i.e., a maximum intensity). A power supply 282 is connected across the outputs of the rectifier 230 to provide a DC supply voltage, V_{CC}, which is used to power the control circuit 280. A communication circuit 284 is coupled to the control circuit 280 and allows the control circuit 280 to communicate with the other ballast 110 on the digital ballast communication link 112. The ballast 110 further comprises a plurality of inputs 290 having an occupancy sensor input 292, a daylight sensor 294, an IR input 296, and a wallstation 298 input. The control circuit 280 is coupled to the plurality of inputs 290 such that the control circuit 280 is responsive to the occupancy sensor, the daylight sensor, the IR receiver 116, and the wallstation 118 of the lighting control system 100. The control circuit 280 is operable to determine a setpoint, i.e., the desired intensity of the connected lamp 102, in response to the communication circuit 284 and the plurality of inputs 290. The control circuit 280 is also coupled to a memory 286 for storage of the operational information of the ballast 110, e.g., the setpoint, the high-end trim, the low-end trim, a serial number, etc.

An example of a digital electronic dimming ballast operable to be coupled to a communication link and a plurality of other input sources is described in greater detail in co-pending commonly-assigned U.S. patent application Ser. No. 10/824,248, filed Apr. 14, 2004, entitled MULTIPLE-INPUT ELECTRONIC BALLAST WITH PROCESSOR, and U.S. patent application Ser. No. 11/011,933, filed Dec. 14, 2004, entitled DISTRIBUTED INTELLIGENCE BALLAST SYSTEM AND EXTENDED LIGHTING CONTROL PROTOCOL. The entire disclosures of both applications are hereby incorporated by reference.

During normal operation of the lighting control system 100, the PC 150 communicates with the ballasts 110 and the electronic drive units 130 using a polling technique. The PC 150 polls the load control devices by transmitting a polling message to each of the ballasts 110 and electronic drive units 130 in turn. To send a polling message to a specific ballast 110, the PC 150 transmits the polling message to the processors 140. If a processor 140 that receives the polling message is coupled to the digital ballast controller 114 that is connected to the specific ballast 110, the processor 140 re-transmits the polling message to the digital ballast controller 114. Upon receipt of the polling message, the digital ballast controller 114 simply re-transmits the polling message to the specific ballast 110.

In response to receiving the polling message, the specific ballast 110 transmits a status message to the PC 150. The status message is transmitted in a relaying fashion back to the PC 150, i.e., in a reverse order than how the polling message is transmitted from the PC 150 to the ballast 110. Preferably, the status message includes the present intensity of the fluorescent lamp. For example, the ballast 110 may transmit the present intensity as a number between 0 and 127 corresponding to the percentage between off (i.e., a number of 0) and the high-end value (i.e., a number of 127).

According to the present invention, the PC 150 estimates a total power consumption of the lighting control system 100 (i.e., a power usage value) using one or more operational characteristics of the ballasts 110 rather than using power meters or current transformers to measure the actual input current of the ballasts. Preferably, the PC 150 simply determines the total amount of power presently being consumed by the lighting control system 100 in response to the number, wattage, and type of lamps 102 connected to the ballasts 110 and the present intensities of the ballasts. Alternatively, a single ballast 110 could be operable to estimate the power consumption of the ballast rather than the PC 150 performing the computation.

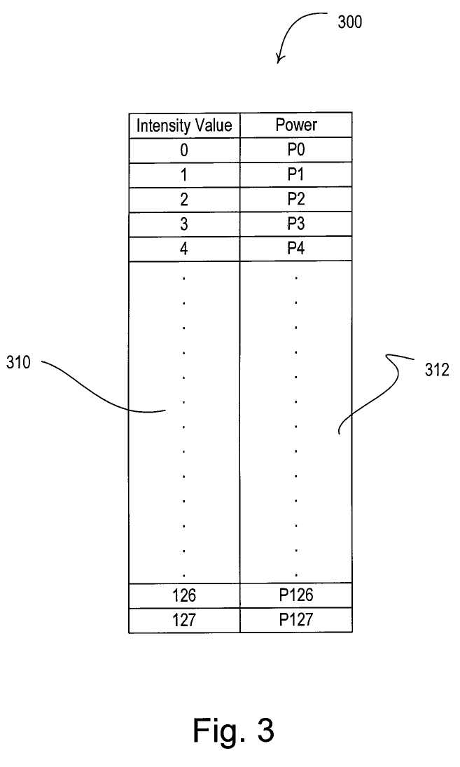

The PC 150 is operable to determine the power presently being consumed by each of the ballasts 110 by using the present intensity of each ballast and one of a plurality of ballast power consumption tables 300. A unique ballast power consumption table 300 (i.e., a look-up table) for each type of ballast is stored in the memory of the PC 150. An example of the format of the ballast power consumption tables 300 is shown in FIG. 3. The table 300 comprises a first column 310 of intensity levels (i.e., index values), which correspond to the lighting intensity levels received by the PC 150 from the ballasts 110, i.e., numbers from 0 to 127. The table 300 also comprises a second column of corresponding power consumption amounts for each of the intensity levels of the first column 310, i.e., P0 through P127 as shown in FIG. 3. The values of the power consumption of the ballast 110 may range, for example, from 14.8 W at low-end to 65 W at high-end for a 277V 10% ballast operating two T5 HE fluorescent lamps in parallel. Preferably, the plurality of ballast power consumption tables 300 are determined by actual measurements of the current drawn by the different types of ballasts at different operating voltages under different operating conditions. The data for the plurality of ballast power consumption tables 300 is then stored in the memory of the PC 150.

The PC 150 determines the power consumption of each ballast by locating the power consumption amount in the second column 320 of the table 300 adjacent the intensity value (that was received from the ballast 110) in the first column 310. For example, if the PC 150 receives an intensity level of three (3) from the ballast 110, the PC 150 assumes that the ballast is presently consuming an amount of power of P3. Once the PC 150 has determined the power consumption of each of the ballast 110 in the lighting control system 100, the PC can sum the power consumption values to determine the total power consumption of the lighting control system 100. Preferably, the PC 150 is operable to display (i.e., graphically represent) the total estimated power consumption of the lighting control system 100 on the screen 156 of the PC. Alternatively, each ballast 110 could store the appropriate power consumption table 300 in the memory 286. Each ballast 110 could then determine the power consumption using the present intensity, and simply transmit the present power consumption to the PC 150.

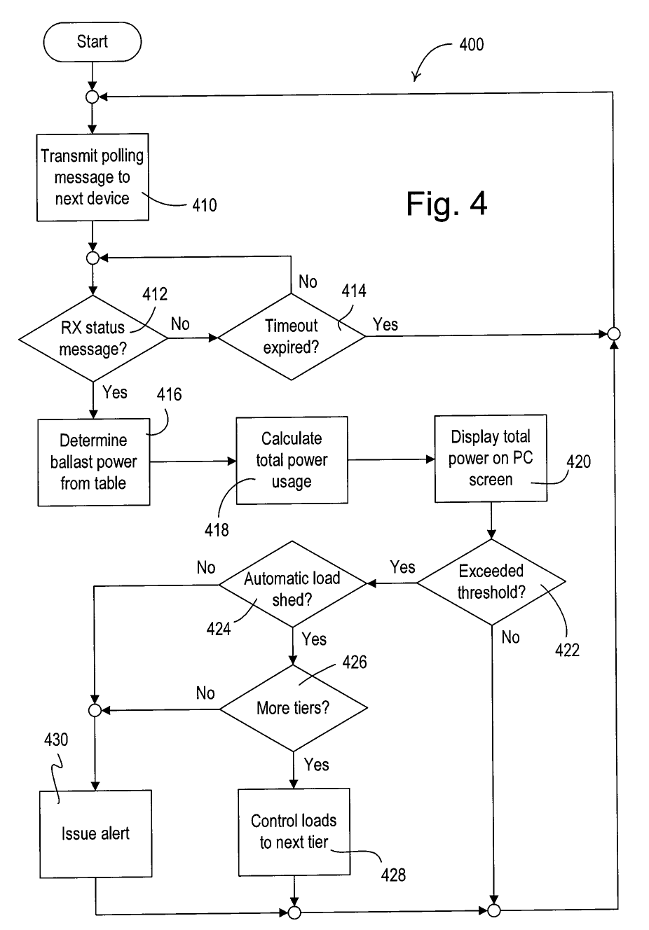

The PC 150 is operable to use the estimated total power consumption as part of a load shedding procedure 400 (shown in FIG. 4). The PC 150 is operable to compare the total power consumption to a load shedding power threshold (i.e., a power usage goal value), which may be set, for example, by a billing threshold of an electrical utility company. If the total power consumption exceeds the threshold, the PC 150 is operable to cause the ballasts 110 to shed loads, i.e., to dim the lamps to a lower intensity, using either a manual load shedding mode or an automatic load shedding mode. When executing the manual load shedding mode, the PC 150 is operable to display on the screen 156 or transmit (e.g., via email) a warning message that the load shedding power threshold has been exceeded. In response to such a warning message, a building manager may manually control the lamps 102 to lower levels, for example, by selecting a lighting preset via the PC 150. The PC 150 is also operable to display on the screen 156 the load shedding power threshold and an estimate of the power savings (i.e., the amount of power that would be consumed without load shedding minus the estimated amount of power presently being consumed using load shedding).

The automatic load shedding mode provides for automatic control of the lamps 102 in response to the power consumption exceeding the load shedding power threshold, rather than requiring a building manager to intervene. During the automatic load shedding mode, the PC 150 dims the lamps in response to the load shedding condition using load shedding “tiers”. A tier is defined as a combination of predetermined load shed parameters (i.e., load shedding amounts) for each of the individual electrical loads or groups of electrical loads. For example, “Tier 1” may comprise shedding loads in an office space by 20%, in a hallway space by 40%, and in a lobby by 10%, while “Tier 2” may comprise shedding loads in the office space by 30%, in the hallway space by 50%, and in the lobby by 30%. Preferably, each successive tier reduces the amount of power being delivered to the electrical loads. Accordingly, the PC 150 is operable to consecutively step through each of the tiers to continue decreasing the total power consumption of the lighting control system 100 if the total power consumption repeatedly exceeds the load shedding threshold.

Preferably, the PC 150 controls each of the ballasts 110 to consume less power by transmitting the load shed parameter (which is chosen according to the next load shedding tier) to each of the ballasts. The load shed parameter represents a level of desired load shedding to be applied to the setpoint determined by the control circuit 280 of each of the ballasts 110 (i.e., the load shed parameter represents a percentage of the present setpoint). After determining the setpoint in response to the communication circuit 284 and the plurality of inputs 290, the control circuit 280 of each ballast 110 preferably multiples the setpoint by a factor that is dependent upon the load shed parameter, as will be described in greater detail below. Since the load control system 100 does not simply reduce the high-end trim of the ballasts 110 in response to the total power consumption exceeding the load shedding power threshold (as in some prior art load control systems), the load control system always controls the lamps 102 to a lower intensity during the load shedding procedure 400 of the present invention, even if the ballasts 110 are receiving inputs from occupancy sensors and daylight sensors.

FIG. 4 is a flowchart of the load shedding procedure 400 executed by the PC 150 according to the present invention. First, the PC 150 transmits a polling message to the next device, i.e., the next ballast 110, at step 410. Preferably, the PC 150 starts with the first ballast 110 and steps through each ballast 110 as the load shedding procedure 400 loops. Next, the procedure 400 loops until the PC 150 receives a status message back from the polled ballast 110 at step 412 or a timeout expires at step 414. If the timeout expires at step 414 before the PC 150 receives a status message at step 412, the PC 150 transmits a polling message to the next ballast 110 at step 410.

If the PC 150 receives a status message back from the polled ballast 110 at step 412, the PC determines the present power consumption of the polled ballast 110 using the intensity level from the status message and the appropriate ballast power consumption table 300 at step 416. To determine which of the plurality of ballast power consumption tables 300 that are stored in memory to use, the PC 150 uses the information about the ballast 110 (i.e., the type of the ballast, the wattage, number of lamps, etc.), which is part of the database stored in memory. At step 418, the PC 150 determines the total power consumption by summing the present power consumption of the each of the individual ballasts 110. At step 420, the PC 150 displays the total power consumption from step 418 on the screen 156.

If the load shedding threshold is exceeded at step 422, a determination is made at step 424 if the automatic load shedding mode is enabled. If so, the PC 150 determines if there are more load shedding tiers to implement at step 426. If there are more load shedding tiers to implement at step 426, the PC controls the ballasts 110 to the intensity levels set by the next tier at step 428. As previously mentioned, the PC 150 updates a load shed parameter of each of the ballasts according to the next tier. Preferably, the load shed parameter has a value that ranges between zero (0) and 100, such that a load shed parameter of zero corresponds to no load shedding, while a load shed parameter of 100 causes the lamp 102 to be turned off. For example, the PC 150 may transmit a load shed parameter of 20 to a first ballast and a load shed parameter of 40 to a second ballast. Accordingly, the first ballast will store the value 20 as its load shed parameter and the second ballast will store the value 40 as its load shed parameter using a load shed parameter update procedure 500.

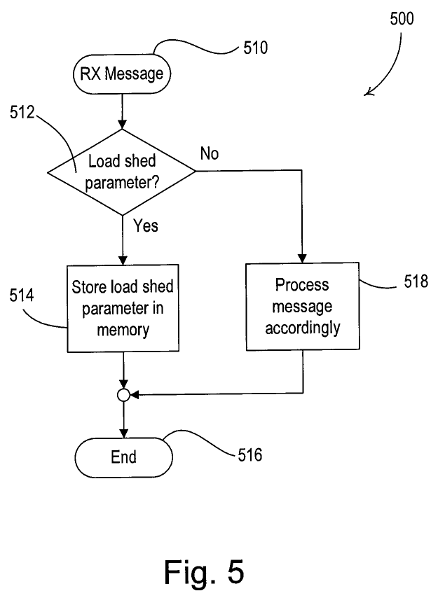

FIG. 5 is a flowchart of the load shed parameter update procedure 500 executed by the control circuit 280 of the ballasts 110 when a digital message is received via the communication circuit 284 at step 510. If the received message is a load shed parameter at step 512, the ballast 110 overwrites the load shed parameter in memory with the new load shed parameter of the received message at step 514 and the procedure 500 exits at step 516. Otherwise, the ballast 110 processes the received message accordingly at step 518 and exits at step 516.

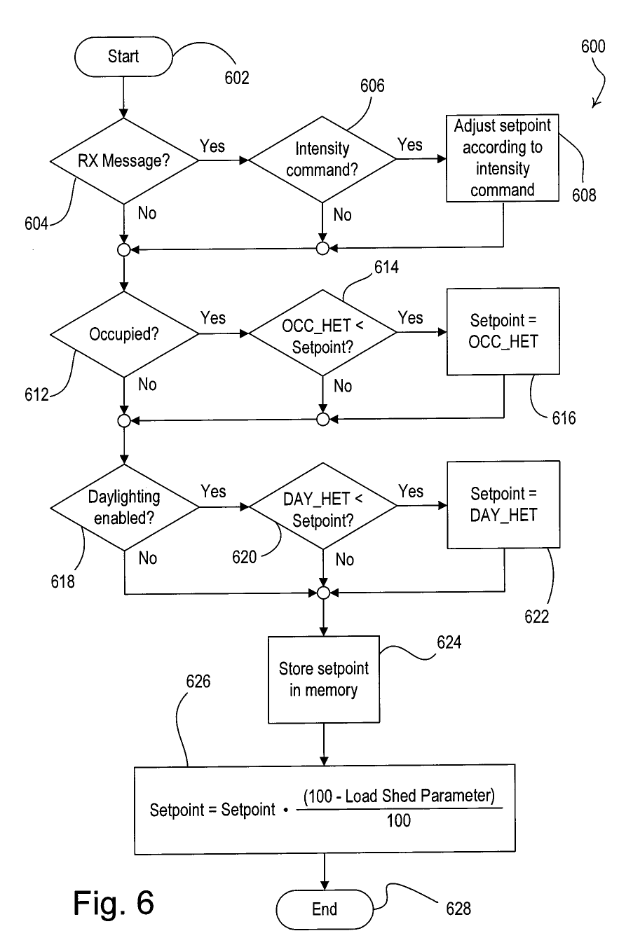

Once the ballast 110 has stored the load shed parameter in memory, the ballast uses a setpoint procedure 600 to determine a lighting setpoint (which controls the intensity of the lamp 102) from the load shed parameter. FIG. 6 is a flowchart of the setpoint procedure 600, which is preferably executed periodically by the control circuit 280 of the ballasts 110, for example, every 2.5 msec. During the setpoint procedure 600, the control circuit 280 uses an occupancy high-end trim (OCC_HET), which represents the high-end trim of the ballast 110 when a connected occupancy sensor has detected an occupied state in the space in which the ballasts 110 and the occupancy sensor are located.

Further, the control circuit 280 uses a daylighting high-end trim (DAY_HET), which represents the high-end trim of the ballast 110 determined from a daylight reading of a connected daylight sensor using a daylighting algorithm. Preferably, the daylighting algorithm attempts to maintain the total illumination (from both daylight and artificial light, i.e., from the lamps 102) in the space in which the ballasts 110 and the daylight sensor are located substantially constant. The daylighting algorithm accomplishes this goal by decreasing the value of the daylighting high-end trim if the total illumination in the space increases, and increasing the value of the daylighting high-end trim if the total illumination decreases. Examples of daylighting algorithms are described in greater detail in commonly-assigned U.S. Pat. No. 4,236,101, issued Nov. 25, 1980, entitled LIGHT CONTROL SYSTEM, and U.S. Pat. No. 7,111,952, issued Sep. 26, 2006, entitled SYSTEM TO CONTROL DAYLIGHT AND ARTIFICIAL ILLUMINATION AND SUN GLARE IN A SPACE. The entire disclosures of both applications are hereby incorporated by reference.

Referring to FIG. 6, the setpoint procedure 600 begins at step 602. If the ballast 110 has received a digital message via the communication circuit 284 at step 604, a determination is made at step 606 as to whether the received message contains an intensity command, i.e., a command to change the intensity of the lamp 102. If so, the control circuit 280 adjusts the setpoint according to the intensity command of the received message at step 608 and the procedure 600 moves on to step 612. If a digital message has not been received at step 604 or the receive message does not contain an intensity command at step 606, the procedure 600 simply continues to step 612.

If an occupancy sensor that is connected to the ballast 110 is signaling that the space is occupied at step 612, a determination is made at step 614 as to whether the occupancy high-end trim OCC_HET is less than the present setpoint. If so, the setpoint is set to the occupancy high-end trim OCC_HET at step 616 and the procedure 600 continues on to step 618. If the space is not occupied at step 612 or the occupancy high-end trim OCC_HET is not less than the present setpoint at step 614, the procedure 600 continues on to step 618, where a determination is made as to whether a daylighting algorithm is enabled. If the daylighting algorithm is enabled at step 618 and the daylighting high-end trim DAY_HET is less than the present setpoint at step 620, the setpoint is set to the daylighting high-end trim DAY_HET at step 622 and the setpoint is stored in memory at step 624. If the daylighting algorithm is not enabled at step 618 or if the daylighting high-end trim DAY_HET is not less than the present setpoint at step 620, the present setpoint is simply stored in memory at step 624.

At step 626, the setpoint is updated based on the load shed parameter that was received during the load shed parameter update procedure 800 of FIG. 8. Specifically, the setpoint is set using the following equation:

Setpoint=Setpoint·(100−Load Shed Parameter)/100. (Equation #1)

For example, if no load shedding is desired, the load shed parameter is zero and the setpoint is not changed according to Equation #1. Further, if the load shed parameter is 100, the setpoint is equal to zero, and thus, the ballast 110 turns the lamp 102 off. A load shed parameter between zero and 100 causes the setpoint to be scaled accordingly. The setpoint procedure 600 exits at step 628.

Therefore, the PC 150 is operable to cause a ballast 110 to begin load shedding by transmitting a load shed parameter having a value greater than zero to the ballast 110. The control and logic in regards to determining the values of the load shed parameters and determining when to automatically shed loads (i.e., if automatic load shedding mode is enabled) is executed by the PC 150.

Referring back to FIG. 7, if the automatic load shedding mode is not enabled at step 724 or if there are not more tiers to implement at step 726, the PC 150 transmits an alert, i.e., sends an email, prints an alert page on a printer, or displays a warning message on the display screen 156. If the load shedding threshold is not exceeded at step 722, the procedure 700 simply loops to poll the next device at step 710.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

What is claimed is:

1. A method of controlling a plurality of electrical loads, the method comprising the steps of:
estimating a present amount of power being consumed by each of the plurality of electrical loads; and
determining the total amount of power presently being consumed by all of the plurality of electrical loads in response to the step of determining a present amount of power being consumed by each of the plurality of electrical loads.

2. The method of claim 1, further comprising the steps of:
comparing the total amount of power to a threshold amount of power; and
controlling the amount of power delivered to the plurality of electrical loads in response to the step of comparing if the total amount of power exceeds the threshold amount of power, such that the plurality of electrical loads consume a second amount of power less than the threshold amount of power.

3. The method of claim 2, further comprising the step of:
providing an alert to a user in response to the step of comparing the total amount of power to a threshold amount of power;
wherein the step of controlling the amount of power delivered to the plurality of electrical loads comprises manually controlling the plurality of electrical loads such that the plurality of electrical loads consume the second amount of power less than the first amount of power.

4. The method of claim 3, wherein the step of providing an alert comprises sending an email.

5. The method of claim 3, wherein the step of providing an alert comprises printing an alert page with a printer.

6. The method of claim 3, wherein the step of providing an alert comprises displaying a warning message on a display screen of a personal computer.

7. The method of claim 1, wherein the electrical loads comprise lighting loads, and the step of determining a present amount of power being consumed by each of the plurality of electrical loads comprises using a present intensity of each of the plurality of loads to determine a present amount of power being consumed by each of the plurality of electrical loads.

8. The method of claim 7, wherein the lookup table comprises a power consumption table having a plurality of intensities as index values, and a plurality of corresponding power consumption values, and the step of determining a present amount of power being consumed by each of the plurality of electrical loads further comprises using the present intensity of a lighting load as the index value of the power consumption table, and using the corresponding power consumption value as the present amount of power being consumed by the electrical load.

9. The method of claim 8, further comprising the step of:
receiving the present intensity of the lighting load.

10. The method of claim 8, further comprising the step of:
transmitting the present amount of power being consumed by the electrical load.

11. The method of claim 1, wherein the step of determining the total amount of power presently being consumed by all of the plurality of electrical loads further comprises summing the present amounts of power being consumed by the plurality of electrical loads.

12. A load control system for controlling the amount of power delivered to a plurality of electrical loads from an AC power source, the system comprising:
a plurality of load control devices coupled to the plurality of electrical loads for control of the amount of power delivered to the plurality of electrical loads, each load control device characterized by a first value corresponding to the present amount of power being delivered to a corresponding at least one of the electrical loads; and
a central controller operatively coupled to the plurality of load control devices, such that the plurality of load control devices are operable to control the amount of power delivered to the plurality of electrical loads in response to the controller;
wherein each of the load control devices is operable to transmit the first value to the controller, and the controller is operable to determine the total amount of power being delivered to all of the electrical loads in response to the first value of each of the plurality of load control devices.

13. The load control system of claim 12, wherein the electrical loads comprise lighting loads, and the controller comprises a memory for storing a power consumption table having a plurality of lighting intensities as index values, and a plurality of corresponding power consumption values.

14. The load control device of claim 13, wherein each of the load control devices is operable to transmit the present lighting intensity of the controlled lighting load to the controller, and the controller is operable to use the present intensity of the controlled lighting load as the index value of the power consumption table, and to use the corresponding power consumption value as the present amount of power being consumed by the electrical load.

15. The load control system of claim 12, wherein the electrical loads comprise lighting loads, and each of the load control devices comprises a memory for storing a power consumption table having a plurality of lighting intensities as index values, and a plurality of corresponding power consumption values.

16. The load control device of claim 15, wherein each of the load control devices is operable to use the present intensity of the controlled lighting load as the index value of the power consumption table, to determine the present amount of power being consumed by the electrical load from the corresponding power consumption value, and to transmit the present amount of power being consumed by the electrical load to the controller.

17. The load control system of claim 12, wherein, if the total amount of power exceeds a threshold amount of power, the controller is operable to cause the load control devices to control the amount of power delivered to the plurality of electrical loads, such that the plurality of electrical loads consume a second amount of power less than the threshold amount of power.

18. The load control device of claim 17, wherein the controller comprises a display screen and is operable to display the total amount of power being delivered to all of the electrical loads on the display screen.

19. The load control device of claim 12, wherein the controller comprises a display screen and is operable to display the total amount of power being delivered to all of the electrical loads on the display screen.

20. A method of controlling a plurality of electrical loads, the method comprising the steps of:
comparing a total amount of power presently being consumed by all of the plurality of electrical loads to a threshold amount of power; and
controlling the amount of power delivered to the plurality of electrical loads in response to the step of comparing if the total amount of power exceeds the threshold amount of power, such that the plurality of electrical loads consume a second amount of power less than the threshold amount of power;
the improvement comprising the steps of:
estimating a present amount of power being consumed by each of the plurality of electrical loads; and
determining the total amount of power presently being consumed by all of the plurality of electrical loads in response to the step of determining a present amount of power being consumed by each of the plurality of electrical loads prior to the step of comparing the total amount of power presently being consumed to a threshold amount of power.

21. A method for using a computing device to reduce power usage for a plurality of load devices without using power meters that measure actual power usage, the method comprising the steps of:
defining a power usage goal value that represents a preferred amount of power to be used for at least one of the plurality of load devices;
estimating a power usage value representing actual power usage for the at least one load device at a particular time; and
automatically reducing power to the at least one load device when the power usage value exceeds the power usage goal value until the power usage value is equal to or lower than the power usage goal value.

22. The method of claim 21, further comprising the step of:
transmitting an alert when the power usage value equals or exceeds the power usage goal value.

23. The method of claim 21, further comprising the step of:
graphically representing at least one of estimated power usage value, the power usage goal value, and an estimate of power savings on a display screen.

24. A system for reducing power usage for a plurality of load devices by using load shedding techniques without using power meters that meter actual power usage, the system comprising:
means for electronically defining a power usage goal value that represents a preferred amount of power to be used by at least one load device;
means for estimating an amount of power usage for the at least one load device at a particular time to calculate a power usage value; and
means for automatically reducing power to the at least one load device when the power usage value exceeds the power usage goal value until the power usage value is equal to or lower than the power usage goal value.

25. A method of automatically reducing power consumption in a load control system having a central controller and a plurality of load control devices controlling the amount of power delivered to a plurality of electrical loads, the method comprising the steps of:
configuring a load shedding tier defining a load shed parameter for each of the electrical loads;
the controller determining the total amount of power presently being consumed by all of the plurality of electrical loads;
the controller comparing the total amount of power to a threshold amount of power;
the controller automatically transmitting a digital message to the plurality of load control devices if the total amount of power exceeds a threshold amount of power; and
the load control devices controlling the amount of power delivered to the electrical loads in accordance with the load shed parameters of the load shedding tier in response to the digital message transmitted by the controller.

26. The method of claim 25, further comprising the steps of:
configuring a first load shedding tier defining a first load shed parameter for each of the electrical loads; and
configuring a second load shedding tier defining a second load shed parameter for each of the electrical loads.

27. The method of claim 26, wherein the amount of power delivered to the electrical loads in accordance with the second load shed parameters of the second load shedding tier is less than the amount of power delivered to the electrical loads in accordance with the second load shed parameters of the second load shedding tier.

28. The method of claim 27, wherein the step of the controller automatically transmitting a digital message to the plurality of load control devices if the total amount of power exceeds a threshold amount of power further comprises:
the controller transmitting the first load shed parameters of the first load shedding tier to the load control devices if the total amount of power exceeds the threshold amount of power a first time; and
the controller subsequently transmitting the second load shed parameters of the first load shedding tier to the load control devices if the total amount of power exceeds the threshold amount of power a second time.

29. The method of claim 28, further comprising the step of:
storing the first and second load shed parameters of the respective first and second load shedding tiers in a memory of the controller.

30. The method of claim 27, wherein the step of the controller automatically transmitting a digital message to the plurality of load control devices if the total amount of power exceeds a threshold amount of power further comprises:
the controller transmitting a first load shedding command to the load control devices if the total amount of power exceeds the threshold amount of power a first time; and
the controller subsequently transmitting a second load shedding command to the load control devices if the total amount of power exceeds the threshold amount of power a second time.

31. The method of claim 28, further comprising the step of:
storing the first and second load shed parameters of the respective first and second load shedding tiers in a memory of the load control devices;
the load control devices controlling the amount of power delivered to the electrical loads in accordance with the first load shed parameters of the first load shedding tier in response to the first load shedding command; and
the load control devices controlling the amount of power delivered to the electrical loads in accordance with the second load shed parameters of the second load shedding tier in response to the second load shedding command.

32. The method of claim 26, further comprising the steps of:
determining if another load shedding tier exists in response to the total amount of power exceeding the threshold amount of power; and
providing an alert to a user if another load shedding tier does not exist.

33. The method of claim 32, wherein the step of providing an alert comprises sending an email.

34. The method of claim 32, wherein the step of providing an alert comprises printing an alert page with a printer.

35. The method of claim 32, wherein the step of providing an alert comprises displaying a warning message on a display screen of a personal computer.

36. The method of claim 25, further comprising the step of:
configuring a plurality of load shedding tiers each defining a different load shed parameter for each of the electrical loads.

37. A load control system for automatically controlling the amount of power delivered from an AC power source to a plurality of electrical loads, the load control system comprising:
a plurality of load control devices coupled to each of the electrical loads for controlling the amount of power delivered to the electrical loads; and
a central controller operable to determine the total amount of power presently being consumed by all of the plurality of electrical loads, compare the total amount of power to a threshold amount of power, and automatically transmit a digital message to the plurality of load control devices if the total amount of power exceeds a threshold amount of power;
wherein the load control devices are each operable to control the amount of power delivered to the connected electrical load in accordance with a load shed parameter of a load shedding tier in response to the digital message transmitted by the controller.

38. The load control system of claim 37, wherein the controller is operable to configure a first load shedding tier defining a first load shed parameter for each of the electrical loads and a second load shedding tier defining a second load shed parameter for each of the electrical loads.

39. The load control system of claim 38, wherein the controller comprises a memory for storing the first and second load shed parameters of the respective first and second load shedding tiers.

40. The load control system of claim 39, wherein the amount of power delivered to the electrical loads in accordance with the second load shed parameters of the second load shedding tier is less than the amount of power delivered to the electrical loads in accordance with the second load shed parameters of the second load shedding tier.

41. The load control system of claim 40, wherein the controller is operable to transmit the first load shed parameters of the first load shedding tier to the load control devices if the total amount of power exceeds the threshold amount of power a first time, and to subsequently transmit the second load shed parameters of the first load shedding tier to the load control devices if the total amount of power exceeds the threshold amount of power a second time.

42. The load control system of claim 38, wherein the controller is operable to determine whether another load shedding tier exists if the total amount of power exceeding the threshold amount of power, and to provide an alert to a user if another load shedding tier does not exist.

43. The load control system of claim 42, wherein the controller comprises a display screen for displaying a warning message.

44. The load control system of claim 35, wherein the controller comprises a memory for storing first and second load shed parameters of respective first and second load shedding tiers.

45. The load control system of claim 44, wherein the controller is operable to transmit a first load shedding command to the load control devices if the total amount of power exceeds the threshold amount of power a first time, and to subsequently transmit a second load shedding command to the load control devices if the total amount of power exceeds the threshold amount of power a second time; and
wherein the load control devices are each operable to control the amount of power delivered to the electrical loads in accordance with the first load shed parameters of the first load shedding tier in response to the first load shedding command, and in accordance with the second load shed parameters of the second load shedding tier in response to the second load shedding command.

46. A central controller for a load control system having a plurality of load control devices for controlling the amount of power delivered from an AC power source to a plurality of electrical loads, the controller comprising:
means for configuring a load shedding tier defining a load shed parameter for each of the electrical loads;
means for determining the total amount of power presently being consumed by all of the plurality of electrical loads;
means for comparing the total amount of power to a threshold amount of power; and
means for automatically transmitting a digital message to the plurality of load control devices if the total amount of power exceeds a threshold amount of power, such that the load control devices control the amount of power delivered to the electrical loads in accordance with the load shed parameters of the load shedding tier in response to the digital message.

47. A load control device of a load control system for controlling the amount of power delivered from an AC power source to an electrical load, the load control device comprising:
a load control circuit adapted to be coupled to the AC power source and the electrical load to control the amount of power delivered to the electrical load;
a control circuit coupled to the load control circuit for controlling the amount of power delivered to the electrical load;
a memory coupled to the control circuit and operable to store a first load shed parameter for a first load shedding tier; and
a communication circuit coupled to the control circuit and operable to receive a digital message representative of the total power of the load control system exceeding a threshold amount of power;
wherein the control circuit is operable to control the amount of power delivered to the electrical load in accordance with the first load shed parameter of the first load shedding tier in response to receiving the digital message a first time.

48. The load control device of claim 47, wherein the memory is operable to store a second load shed parameter for a second load shedding tier, and the control circuit is operable to control the amount of power delivered to the electrical load in accordance with the second load shed parameter of the second load shedding tier in response to receiving the digital message a second time.

49. A method of determining a setpoint of a load control device for controlling the amount of power delivered to an electrical load located in a space, the method comprising the steps of:
initially setting the value of the setpoint equal to a desired level;
limiting the value of the setpoint to an occupied high-end trim if the space is occupied;
limiting the value of the setpoint to a daylighting high-end trim determined by a daylighting procedure; and
subsequently reducing the value of the setpoint in response to a load shed parameter.

50. The method of claim 49, wherein, as the value of the load shed parameter increases, the value of the setpoint decreases.

51. The method of claim 50, wherein the step of subsequently reducing the value of the setpoint in response to a load shed parameter comprises calculating the value of the new setpoint as a function of the previous setpoint and the load shed parameter.

52. The method of claim 52, wherein the step of subsequently reducing the value of the setpoint in response to a load shed parameter comprises multiplying the setpoint by a factor that is dependent upon the load shed parameter.

53. The method of claim 52, wherein the step of subsequently reducing the value of the setpoint in response to a load shed parameter comprises calculating the value of the new setpoint from the equation:
New Setpoint=Previous Setpoint(100−Load Shed Parameter)/100.

54. The method of claim 49, further comprising the step of:
controlling the amount of power delivered to the electrical load in response to the setpoint.

55. The method of claim 49, wherein the value of the load shed parameter is determined as part of a load shedding procedure.

56. The method of claim 49, further comprising the step of:
receiving a digital message containing a command to control the amount of power delivered to the electrical load to the desired level.

57. The method of claim 49, further comprising the steps of:
increasing the daylighting high-end trim if the daylighting procedure determines that the amount of daylight in the space has decreased; and
decreasing the daylighting high-end trim if the daylighting procedure determines that the amount of daylight in the space has increased.

58. A method of controlling the amount of power delivered from an AC power source to an electrical load located in a space, the method comprising the steps of:
receiving a digital message containing a command to control the amount of power delivered to the electrical load to a desired level;
detecting if the space is occupied; and
determining a daylighting high-end trim using a daylighting procedure;
wherein the improvement comprises the steps of:
receiving a load shed parameter; and
determining the amount of power to be delivered to the electrical load by limiting the amount of power to be delivered to the electrical load to the minimum of the desired level of the digital message, an occupied high-end trim, and the daylighting high-end trim, and by reducing the amount of power to be delivered to the electrical load in response to the load shed parameter.

59. A load control device for controlling the amount of power delivered from an AC power source to an electrical load located in a space, the load control device comprising:
means for initially setting the value of the setpoint equal to a desired level;
means for limiting the value of the setpoint to an occupied high-end trim if the space is occupied;
means for limiting the value of the setpoint to a daylighting high-end trim determined by a daylighting procedure; and
means for subsequently reducing the value of the setpoint in response to a load shed parameter.

60. A load control device of a load control system for controlling the amount of power delivered from an AC power source to an electrical load located in a space, the load control device comprising:
a load control circuit adapted to be coupled to the AC power source and the electrical load to control the amount of power delivered to the electrical load;
a control circuit coupled to the load control circuit for controlling the amount of power delivered to the electrical load;
a memory coupled to the control circuit and operable to store a load shed parameter;
a communication circuit coupled to the control circuit and operable to receive a digital message representative of a desired amount of power to deliver to the electrical load;
an occupancy sensor input for receiving an occupancy sensor signal representative of whether the space is occupied, the control circuit operable to determine an occupied high-end trim in response to the occupancy sensor signal; and
a daylight sensor input for receiving a daylight sensor signal representative of the total illumination in the space, the control circuit operable to determine a daylighting high-end trim in response to the daylighting sensor signal;
wherein the control circuit is operable to determine the amount of power to be delivered to the electrical load by limiting the amount of power to be delivered to the electrical load to the minimum of the desired level of the digital message, the occupied high-end trim, and the daylighting high-end trim, and by reducing the amount of power to be delivered to the electrical load in response to the load shed parameter.

61. A load control device of claim 60, wherein the control circuit is operable to receive the load shed parameter via the communication circuit, and to store the load shed parameter in the memory.
